(19) United States
(12) Patent Application Publication
(10) Pub. No.: US 2008/0241048 A1
(43) Pub. Date: Oct. 2, 2008

(54) Carbonates and Method for Producing the Same

(75) Inventor: Tetsuo Kawano, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Minato-ku (JP)

(21) Appl. No.: 12/053,682

(22) Filed: Mar. 24, 2008

(30) Foreign Application Priority Data
Mar. 30, 2007 (JP) 2007-093044

(51) Int. Cl. C01B 31/24

(52) U.S. Cl. 423/432; 423/419.1; 423/430

(57) ABSTRACT

The present invention provides a method for producing carbonates, which includes at least adding an aqueous solution containing a carbonate source into an alcoholic solution containing a metal ion source, wherein an alkaline chemical is added when the carbonate source is reacted with the metal ion source.

### BACKGROUND OF THE INVENTION

1. Field of the Invention

The present invention relates to a method for producing carbonates, by which carbonates having an orientation birefringence, especially needle- or rod-shaped strontium carbonate, can be formed efficiently and easily at around room temperature without heating control of 50° C. or higher and their particle sizes can be controlled.

2. Description of the Related Art

So far, carbonates, such as strontium carbonate, have been widely used in the fields of rubber, plastic, paper and the like. In recent years, carbonates having high-functionality are successively developed and used for various applications and purposes depending on the particle shape and the particle diameter.

For crystal forms of carbonates, there are calcite crystal form, aragonite crystal form, vaterite crystal form, and the like. Among them, aragonite crystals of the carbonates have a needle-like form and find a fit for various applications in terms of excellence in strength and elastic modulus.

For methods of producing carbonates, following methods are generally known, that is, a method in which carbonates are produced by reacting a carbonate ion-containing solution with a chloride solution, and a method in which carbonates are produced by reacting a chloride solution with carbon dioxide gas. In addition, for a method of producing needle-like carbonates with aragonite structure, following methods have been proposed, that is, for example, a method in which in the former method described above, a carbonate ion-containing solution is reacted with a chloride solution under ultrasonic treatment (see Japanese Patent Application Laid-Open (JP-A) No. 59-203728), a method of introducing carbon dioxide in a Ca(OH)₂ water slurry in which needle-like aragonite crystals of seed crystals are placed in a Ca(OH)₂ water slurry beforehand, and the seed crystals are made to grow only in a certain direction (U.S. Pat. No. 5,164,172), and a method in which sodium aluminate is added to a calcium hydroxide slurry, the resultant mixture is heated at 50° C. or higher and reacted with a carbon dioxide gas blown thereto (JP-A No. 08-2914).

However, in the method for producing carbonates described in JP-A No. 59-203728, there is a problem that it is impossible to obtain carbonates which are controlled to have a desired particle size, because the length of the obtained carbonates is excessively long, i.e., 30 μm to 60 μm, and the obtained carbonates have a wide particle size distribution. In the carbonate production method described in U.S. Pat. No. 5,164,172, there is also a problem that it gives only large size particles of a length of 20 μm to 30 μm. Furthermore, in the carbonate production method described in JP-A No. 08-2914, heating control must be conducted in production process.

In recent years, for materials of general optical components such as glass lenses, and transparent plates, and materials of optical components for opto-electronics, especially for optical components used for laser-related devices such as optical disc devices for recording sounds, images, literal information and the like, there is a strong tendency to use polymeric resins. The reason is that polymeric optical materials (optical materials made of a polymeric resin) are generally lighter in weight and cheaper than other optical materials such as optical glasses, thus, superior in processability and mass productivity. Further, polymeric resins have an advantage that molding techniques such as injection molding and extrusion molding are easily applied.

However, when a conventional general polymeric optical material is subjected to a molding technique to produce a product, the product thus obtained has a characteristic of a birefringence. When polymeric optical materials having a birefringence are used for optical elements in which high precision is not required relatively, no particular problem arises, however, optical components that require higher precision have been requested in recent years. For example, in recordable/erasable magneto-optical discs, the birefringence presents a significant problem. In these magneto-optical discs, polarized beams are used for reading beam or recording beam, and when a birefringent optical element such as a disc itself or a lens exists on an optical path, it adversely affects the precision of reading or recording.

Then, aiming to reduce birefringence, a non-birefringent optical resin material using a polymeric resin and inorganic fine particles which have different birefringent signs each other has been proposed (see International Publication No. WO 01/25364). Such non-birefringent optical resin material can be obtained by a technique called crystal doping method. Specifically, a number of inorganic fine particles are dispersed in a polymeric resin, linked chains of the polymeric resin are orientated generally parallel to the inorganic fine particles by externally applying a molding force by drawing, etc. to thereby counteract birefringence caused by the orientation of linked chains of the polymeric resin with birefringence of the inorganic fine particles which have different signs from those of the polymeric resin.

As described above, to obtain a non-birefringent optical resin material using the crystal doping method, inorganic fine particles which are available for the crystal doping method are essential, and for the inorganic fine particles, it is recognized that needle-or rod-like minute carbonates are particularly suitably applicable.

Against the background of these circumstances, many approaches have been taken to control sizes and shapes of the inorganic fine particles; however a problem of large variance of particle sizes has been unsolved. In addition, in conventional synthesis methods, crystallinity of particles obtained was poor, and there was fear that optical properties (birefringence of particles) were degraded.

To solve these problems, a method is described in Langmuir, 2005, vol. 21(1), pp. 100-108, in which nanosized seed crystals (calcium carbonate) were produced using PAA (polyacrylic acid) and calcium carbonate particles were obtained using the nanosized seed crystals. The study indicates a fact that in some cases a crystal type of calcium carbonate (there are three crystal types in calcium carbonate, that is calcite, vaterite, and aragonite) can be controlled by selecting seed crystals of the desired crystal type, however, many of particles obtained have a spindle-shape and a spherical shape, etc. and in particular, particles having a large aspect ratio have not been obtained.

Meanwhile, Chem Mater. 2003, vol. 15(6), pp. 1322-1326 describes a method in which carbonate particles were formed by a decomposition reaction of urea (thermal decomposition or enzymatic decomposition using urease) in a solution containing Sr salt or Ba salt and urea. In terms of decomposition rate of urea, the enzymatic decomposition proceeds faster than the thermal decomposition and is preferable. However, in terms of reduction of impurities, in some cases the thermal decomposition is preferable.

Since the thermal decomposition of urea proceeds slowly, numbers of cores produced become small. Although needle-like particles having a large aspect ratio can be obtained, particles obtained become larger (see FIG. 1c in this literature). In addition when urea decomposition was performed using enzymes, particles obtained become spherical in shape, contain enzymes (proteins) in them, thus there arises a concern of contamination, etc. when such particles are introduced into final materials.

Meanwhile the present inventors proposed previously in JP-A No. 2006-193411 a method for producing carbonates in which carbonates having an orientation birefringent and an aspect ratio greater than 1 can be formed efficiently and easily and particle sizes can be controlled.

Specifically, the production method is a method for producing carbonates having an aspect ratio greater than 1 in which a metal ion source containing at least one metal ion selected from the group consisting of Sr²⁺ ion, Ca²⁺ ion, Ba²⁺ ion, Zn²⁺ ion, and Pb²⁺ ion is reacted with a carbonate source in a liquid, including a number increasing step of carbonate particles for increasing the number of carbonate particles, and a volume increasing step of carbonate particles for increasing only volumes of the carbonate particles. That Japanese Patent Application Laid-Open describes that, in order to obtain particles with even sizes and shapes, it is important to separate clearly the number increasing step of particles and the volume increasing step of particles.

However, it is difficult to obtain particles of small sizes at a final step unless minute particles are obtained in the first step of increasing the number of carbonate particles, even when merely the separation of the steps described above is achieved. Particles having a size level of a micrometer or greater are substantially difficult to be added and provided to a transparent polymeric film, leaving a problem.

Thus, at present, a method for producing carbonates is urgently requested in which, by further lowering solubility of the target composition in an addition step of an aqueous solution containing a carbonate source into an alcohol solution containing a metal ion source, sizes can be controlled even for particles of average major axis length of less than 1 μm.

### BRIEF SUMMARY OF THE INVENTION

An object of the present invention is to provide carbonates having an average aspect ratio greater than 2, an average major axis length of nonconventional sizes, and average minor axis lengths of even sizes, and to provide an efficient production method for such carbonates, by adding an aqueous solution containing a carbonate source and keeping a highly-alkalic state by NaOH, etc., into an alcoholic solution containing a metal ion source.

Means to solve above problems are as follows:
<1> A method for producing carbonates, including adding an aqueous solution containing a carbonate source into an alcoholic solution containing a metal ion source, wherein an alkaline chemical is added when the carbonate source is reacted with the metal ion source.
<2> The method for producing carbonates according to the item <1>, wherein a metal ion in the metal ion source is Sr²⁺.
<3> The method for producing carbonates according to any one of the items <1> to <2>, wherein the alkaline chemical is added to the aqueous solution containing a carbonate source.
<4> The method for producing carbonates according to any one of the items <1> to <3>, wherein the alkaline chemical contains at least one selected from the group consisting of NaOH, KOH, and LiOH.
<5> The method for producing carbonates according to any one of the items <1> to <4>, wherein an alcohol is added to the aqueous solution containing a carbonate source.
<6>The method for producing carbonates according to any one of the items <1> to <5>, wherein the aqueous solution containing a carbonate source is added at least at two different temperatures in the order of higher temperature.
<7>The method for producing carbonates according to any one of the items <1> to <6>, wherein the aqueous solution containing a carbonate source is added at a first temperature of 10° C. or lower and at a second temperature of 30° C. or higher.
<8> The method for producing carbonates according to any one of the items <1> to <7>, wherein the metal ion source contains at least one selected from the group consisting of hydroxides, chlorides, and nitrates of strontium, and the carbonate source contains at least one selected from the group consisting of sodium carbonates, potassium carbonates, and ammonium carbonates.
<9> Carbonates produced by a method for producing carbonates according to any one of the items <1> to <8>.
<10> The carbonates according to the item <9>, wherein the carbonates have an average aspect ratio of two or more and an average major axis length of shorter than 1 μm.
<11> Carbonates, having an average major axis length of less than 200 nm, a coefficient of variation of the average major axis length of 45% or less, an average minor axis length of less than 65 nm and a coefficient of variation of the average minor axis length of 20% or less.

The present invention can solve the above noted conventional problems and provide carbonates having an average aspect ratio greater than 2, an average major axis length of nonconventional sizes, and an average minor axis length of even sizes, and an efficient production method for such carbonates by adding an aqueous solution containing a carbonate source and keeping alkalinity by NaOH, etc., into an alcoholic solution containing a metal ion source.

### BRIEF DESCRIPTION OF THE SEVERAL VIEWS OF THE DRAWINGS

FIG. 1A is a transmission electron microscope (TEM) photograph (magnification of ×10,000) of strontium carbonate produced in Example 1.

FIG. 1B is a TEM photograph (×50,000) of strontium carbonate produced in Example 1.

FIG. 2A is a TEM photograph (×10,000) of strontium carbonate produced in Example 2.

FIG. 2B is a TEM photograph (×50,000) of strontium carbonate produced in Example 2.

FIG. 3A is a TEM photograph (×10,000) of strontium carbonate produced in Comparative Example 1.

FIG. 3B is a TEM photograph (×50,000) of strontium carbonate produced in Comparative Example 1.

FIG. 4A is a TEM photograph (×10,000) of strontium carbonate produced in Comparative Example 2.

FIG. 4B is a TEM photograph (×50,000) of strontium carbonate produced in Comparative Example 2.

FIG. 5 is a plot of measured values of major axis length versus minor axis length in Example 1.

FIG. 6 is a plot of measured values of major axis length versus minor axis length in Comparative Example 1.

FIG. 7 is a graph showing a solubility curve (calculated values and experimental values) of strontium carbonate.

FIG. 8 is a schematic diagram for a description of method for producing carbonates according to a single-jet method.

### DETAILED DESCRIPTION OF THE INVENTION

### (Method for Producing Carbonates and Carbonates)

A method for producing carbonates of the present invention includes at least adding an aqueous solution containing a carbonate source into an alcohol solution containing a metal ion source and further includes other steps as required.

Carbonates of the present invention are produced by the method for producing carbonates of the present invention.

The carbonates of the present invention are also described in detail as follows through a description of the production method of the carbonates of the present invention.

### —Metal Ion Source—

The metal ion source is not particularly limited, as long as the metal ion source contains metal ion s, may be suitably selected depending on the purpose, however, those capable of reacting with the carbonate source and forming carbonates having a calcite crystal form, aragonite crystal form, vaterite crystal form or amorphous crystal form are preferable, and those capable of forming carbonates having an aragonite crystal form are particularly preferable.

The aragonite crystal structure is represented by CO₃²⁻ units, and the CO₃²⁻ units are layered to form carbonates having any one of a needle-like and a rod-like shape. Because of this, when the carbonates are drawn in a given direction by a drawing treatment described below, the crystals are arrayed in a state where the major axes of the carbonate particles are arrayed in the drawing direction.

Table 1 shows refractive indexes of minerals in an aragonite crystal form.

TABLE 1

| | | | | | Specific |
|---|---|---|---|---|---|
| | α | β | γ | δ | Gravity |
| CaCO₃ | 1.530 | 1.681 | 1.685 | 0.155 | 2.94 |
| SrCO₃ | 1.520 | 1.667 | 1.669 | 0.149 | 3.75 |
| BaCO₃ | 1.529 | 1.676 | 1.677 | 0.148 | 4.29 |
| PbCO₃ | 1.804 | 2.076 | 2.078 | 0.274 | 6.55 |

As shown in Table 1, since carbonates having an aragonite crystal structure have a high birefringent index δ, the carbonates can be suitably used for doping to polymers having an orientation birefringence.

The metal ion source is not particularly limited, may be suitably selected depending on the purpose as long as it contains at least one metal ion selected from the group consisting of Sr²⁺ ions, Ca²⁺ ions, Ba²⁺ ions, Zn²⁺ ions, and Pb²⁺ ions, and examples thereof include nitrates, chlorides, and hydroxides of at least one metal selected from Sr, Ca, Ba, Zn, and Pb. Among them, at least one metal ion source selected from the group consisting of a hydroxide, chloride, and nitrate of strontium is particularly preferable.

The metal ion source preferably includes at least any one of NO₃⁻, Cl⁻, and OH⁻. Thus, specific examples of the metal ion source suitably include Sr(NO₃)₂, Ca(NO₃)₂, Ba(NO₃)₂, Zn(NO₃)₂, Pb(NO₃)₂, SrCl₂, CaCl₂, BaCl₂, ZnCl₂, PbCl₂, Sr(OH)₂, Ca(OH)₂, Ba(OH)₂, Zn(OH)₂, Pb(OH)₂, and hydrates thereof.

When strontium carbonate is produced, as a metal ion source, Sr(OH)₂.8H₂O is particularly preferable.

The metal ion source is added to alcohol and it is used as an alcohol solution containing a mixture of the metal ion sources.

The alcohol used in the alcohol solution containing the metal ion sources is not particularly limited, may be selected suitably depending on the purpose, and includes, for example, methanol, ethanol, and isopropyl alcohol, etc. These may be used alone or in combination of two or more.

The alcohol solution containing the metallic source may contain water, however, the alcohol solution containing the metallic source preferably contains as much alcohol as possible, and particularly preferably contains no water (an alcohol content of 100%) before the reaction with a carbonate source.

### —Carbonate Source—

The carbonate source is not particularly limited and may be suitably selected depending on the purpose as long as it produces CO₃²⁻ ions. Examples of the carbonate source suitably include ammonium carbonate [(NH₄)₂CO₃], sodium carbonate [Na₂CO₃], sodium hydrogencarbonate [NaHCO₃], potassium hydrogencarbonate [KHCO₃], carbon dioxide gas, and urea [(NH₂)₂CO]. Among them, ammonium carbonate [(NH₄)₂CO₃], sodium carbonate [Na₂CO₃], and potassium hydrogencarbonate [KHCO₃] are particularly preferable.

When as a metallic source required for carbonate formation, strontium hydroxide octahydrate, for example, is used in the present invention, the solution containing the Sr²⁺ ion source is alkaline because the strontium hydroxide octahydrate is alkaline. However, as a reaction proceeds (in accordance with addition of an aqueous solution containing a carbonate source), pH declines, which necessitates an alkaline chemical addition at the time of the reaction between the carbonate source and the metal ion source.

The alkaline chemical addition is not particularly limited as long as it is performed at the time of reaction between the carbonate source and the metal ion source. The alkaline chemical may be added to the aqueous solution containing a carbonate source beforehand or may be added alone, however, the former is particularly preferable because this prevents heterogeneous alkaline chemical concentration (pH) as much as possible.

The alkaline chemical is not particularly limited, may be selected suitably depending on the purpose, and includes for example NaOH, KOH, and LiOH, etc. The addition amount of the alkaline chemical is preferably an amount with which pH of the reaction solution of 10 or higher can be kept, since in order to obtain minute particles of carbonates, the carbonates are preferably precipitated under the condition of a low solubility of the carbonates.

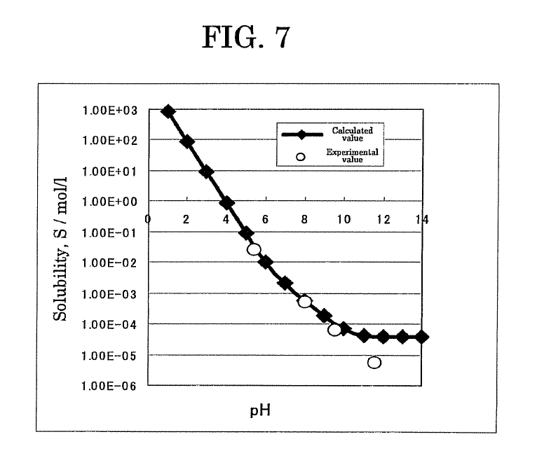

FIG. 7 is a graph showing a solubility curve (solvent: water) calculated using solubility product values of strontium carbonate and a result (experimental values) of an experiment in which commercially available strontium carbonate particles (manufactured by Wako Pure Chemical Industries, Ltd.) are actually dispersed in aqueous solutions with varying pHs, supersaturated solutions obtained by removing solid strontium carbonates (filtration treatment) are subjected to ICP emission spectrometry for quantification of strontium carbonate solutes, and the solubility resulting from the experiment was plotted against pH values. A solubility of strontium carbonate is known to decrease as pH increases. Since the solubility decreases almost to a limit at around pH 10 or higher, it is considered that carbonate precipitations in a reaction solution kept at pH 10 or higher may produce minute carbonates.

It is preferable to add an alcohol to the aqueous solution containing the carbonate source. The alcohol is not particularly limited, may be selected suitably depending on the purpose, and includes for example methanol, ethanol, and isopropyl alcohol, etc. These may be used alone or in combination of two or more.

The alcohol content of the aqueous solution containing the carbonate source is preferably 95% by volume, more preferably 90% by volume. When the alcohol content is higher than 95% by volume, particles become easier to precipitate, sometimes resulting in particles with small average aspect ratio.

—Method For Reacting Metal Ion Source with Carbonate Source—

The method for reacting a metal ion source with a carbonate source in a solution is not particularly limited, may be selected suitably depending on the purpose, however, in terms of reactivity, a single-jet method described below is particularly preferable.

### —Single-Jet Method—

The single-jet method is a method, in which any one of the metal ion source and the carbonate source is added by jetting to the surface of another source solution or in the other source solution to be reacted each other.

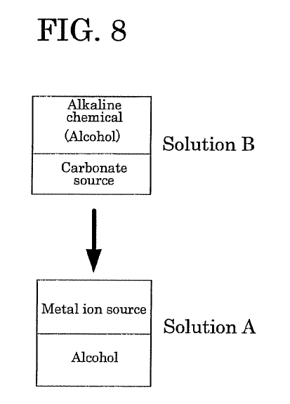

The single-jet method can be performed using, for example, a single-jet reaction crystallizer. The crystallizer has a stirring blade in a reaction vessel, and is equipped with a nozzle for supplying a material solution into a site near the stirring blade. The number of nozzles may be one; two or more nozzles can be used without a problem. As shown in FIG. 8, for example, it is possible to add and react a metal ion source (solution A) in a tank with a carbonate source (solution B) jetted from the nozzle.

The molar adding rate of the metal ion source and the carbonate source by the single-jet method is not particularly limited, may be selected suitably depending on the purpose, however, the molar adding rate is preferably determined as a stoichiometrical ratio of the final products.

In the present invention, depending on the molar adding rate selected, in some cases any one of the metal ion source and the carbonate source are not jetted but added to the other source solution, however, this experimental situation does belong to the single-jet method.

Stirring speeds in single-jet method are preferably 500 rpm to 1,500 rpm.

Addition of the aqueous solution containing the carbonate source is preferably performed at at least two different temperatures in the order of higher temperature. The first temperature is preferably 10° C. or lower, more preferably −10° C. to 10° C. The second temperature is preferably 30° C. or higher, and more preferably a temperature not above the boiling point of the alcohol.

The method for producing carbonates of the present invention preferably contains a step for increasing the number of carbonate particles (hereinafter simply called as a number increasing step of carbonate particles) and a step for increasing only the volume of carbonate particles (hereinafter simply called as a volume increasing step of carbonate particles) as described below.

### —Number Increasing Step of Carbonate Particles—

The number increasing step of carbonate particles is not particularly limited, may be suitably selected depending on the purpose as long as the number of carbonate particles can be increased after forming carbonates, and examples thereof include a step in which at least one of the metal ion source and the carbonate source is added in a solution with a given reaction temperature and the added solution is mixed with the solution containing the other source. When reacting these solutions according to a single-jet method, more specific and preferred examples thereof include a step in which while maintaining the reaction temperature of any one of a metal ion source-containing solution or a metal ion source-containing suspension at a given value, a carbonate source-containing aqueous solution is added to the metal ion source-containing alcoholic solution or suspension at a given adding rate to be mixed with each other.

The reaction temperature is preferably −10° C. to 40° C., and more preferably 1° C. to 40° C. When the temperature in the number increasing step of the carbonate particles is lower than −10° C., there may be cases where either of needle-like or rod-like carbonates cannot be obtained, and spherically shaped or elliptical carbonates are formed. When the temperature is more than 40° C., there may be cases where the size of the primary particles of the carbonate is increased, and nanosized carbonates having an aspect ratio greater than 1 cannot be obtained.

The adding rate of the carbonate source-containing aqueous solution is not particularly limited, may be suitably selected depending on the purpose.

Each of the number of moles of the metal ion source and the carbonate source to be reacted in the number increasing step of the carbonate particles is not particularly limited as long as it is within the range where the number of particles can be increased, and may be suitably selected depending on the purpose. For example, the number of moles of the metal ion source may be equal to the number of moles of the carbonate source, or the number of moles of the metal ion source is greater than that of a carbonate source.

The metal ion source and the carbonate source when reacted according to the single-jet method, for example, may be mixed during and after any one of the metal ion source and the carbonate source may be added to the other source.

For a method for verifying the number increase of the carbonate particles, for example, there is a method in which carbonate particles are observed using a transmission electron microscope (TEM) or a scanning electron microscope (SEM) to verify that no impurity is mixed therein, and the number of the carbonate particles is counted.

### —Volume Increasing Step of Carbonate Particles—

The volume increasing step of the carbonate particles is not particularly limited, may be suitably selected depending on the purpose as long as only the volume of carbonate particles can be increased without increasing the number of carbonate particles, for example, there is a method in which at least one of the metal ion source and the carbonate source is added to the solution containing the carbonate precipitates under conditions of a temperature higher than the reaction temperature of the number increasing step of carbonate particles and of an adding rate slower than that of the number increasing step of carbonate particles to be mixed. It should be noted that not to increase the number of carbonate particles in the volume increasing step means that the number of carbonate particles after the volume increasing step is not increased by more than 40% relative to the number of carbonate particles upon completion of the number increasing step. The number of carbonate particles after the volume increasing step preferably is not increased by more than 30% relative to the number of carbonate particles upon completion of the number increasing step, and more preferably is not increased by more than 20%.

For more specific and preferred steps, for example, a step is included in which any one of the carbonate source-containing aqueous solution and the gas is added under a temperature condition of the reaction temperature of the number increasing step or higher, and the resultant added solution is mixed.

The reaction temperature is preferably −10° C. or more, and more preferably 1° C. to 40° C. When the reaction temperature is lower than −10° C., sometimes handling the products after the formation of the particles becomes cumbersome because solvents available are limited.

The adding rate is not particularly limited and may be suitably selected depending on the purpose.

Each of the number of moles of the metal ion source and the carbonate source to be reacted in the volume increasing step of carbonate particles is not particularly limited and may be suitably selected depending on the purpose as long as they are in the range where only the volume of carbonate particles can be increased without increasing the number of carbonate particles. For example, when the number of moles of the metal ion source is equal to the number of moles of the carbonate source in the number increasing step of carbonate particles, it is preferable that the number of moles of the metal ion source to be reacted is equal to the number of moles of the carbonate source in the volume increasing step of carbonate particles, and the number of moles of the metal ion source to be reacted in the volume increasing step is the number of moles of the metal ion source in the number increasing step or more.

When carbonate particles are formed by reacting the metal ion source (a) with the carbonate source (b) in the number increasing step such that the number of moles of the metal ion source (a) is greater than that of the carbonate source (b), it is preferable to react the carbonate source having the number of moles equal or greater than the difference between the number of moles of the metal ion source (a) and the number of moles of the carbonate source (b) in the product from the number increasing step to increase the volume of the carbonate particles, in terms of obtaining carbonates with a high aspect ratio.

The carbonate source to be reacted in the volume increasing step of carbonate particles is not particularly limited and may be suitably selected depending on the purpose as long as it is any one of the above-described carbonate sources, however, the carbonate source to be reacted in the number increasing step described above may be the same compound as that of the carbonate source to be reacted in the volume increasing step, in terms of efficiency of the reaction.

For the method for verifying the volume increase of the carbonate particles, for example, a method is included in which carbonate particles are observed by using a transmission electron microscope (TEM) or a scanning electron microscope (SEM) to verify that no impurity is mixed therein and then the sizes of the carbonate particles are measured.

Solution in Which Metal Ion Source is Reacted with Carbonate Source—

The solution in which the metal ion source is reacted with the carbonate source preferably contains water. Thus, the solution in which the metal ion source is reacted with the carbonate source is preferably an aqueous solution or a suspension.

Further, in order to decrease the solubility of crystals of carbonates to be synthesized, the aqueous solution or the suspension preferably contains a solvent.

The solvent is not particularly limited, may be suitably selected depending on the purpose as long as it is water-miscible, and examples thereof suitably include methanol, ethanol, 1-propanol, isopropyl alcohol, 2-aminoethanol, 2-methoxyethanol, acetone, tetrahydrofuran, 1,4-dioxane, N,N-dimethylformamide, N,N-dimethylacetamide, N-methylpyrrolidone, 1,3-dimethyl-2-imidazolidone, and dimethylsulfoxide. These may be used alone or in combination of two or more. Among them, ethanol, isopropyl alcohol, and 2-aminoethanol are particularly preferable in terms of reactivity and availability of the material.

The added amount of the solvent is preferably 1% by volume to 50% by volume of the amount of the solution after the carbonate production, and more preferably 5% by volume to 40% by volume thereof.

### —Physical Properties of Carbonate—

Carbonates produced by the method for producing carbonates of the present invention preferably have an average aspect ratio of 2 or more, and more preferably of 3.0 to 20. When the average aspect ratio is less than 2, the carbonate crystals become nearly granular or nearly spherical, the probability of occurrence of orientation of the carbonate particles is lowered according to the molecular orientation of a transparent resin in the resins or no molecular orientation occurs, which results in loss of effects of the present invention.

The average aspect ratio represents a ratio of a major axis length and a minor axis length of the carbonates, and the larger the average aspect ratio is the more preferable.

The average major axis length is preferably less than 1 μm, more preferably 300 nm or less, and most preferably 200 nm or less. When the average major axis length is longer than 1 μm, a transmittance is sometimes greatly reduced when the carbonate product is added into an optical resin material.

Furthermore, carbonates of the present invention preferably have small variations. Preferably carbonates of the present invention have an average major axis length of less than 200 nm, a coefficient of variation thereof of 45% or less, and an average minor axis length of less than 65 nm, and a coefficient of variation thereof of 20% or less.

A coefficient of variation of the major axis length or the minor axis length is represented by a ratio of a standard deviation to the average value of the major axis length or the minor length, calculated using following mathematical formula (1) and expressed as a percentage of the average value.

$$\frac{1}{r} \times {\{ \frac{1}{n - 1} {\sum }_{i = 1}^{n} {( {r}_{i} - r )}^{2} \}}^{\frac{1}{2}} \qquad Mathematical Formula ( 1 )$$

In the mathematical formula (1), r represents the average of the major axis lengths; n represents the number of particles measured for the calculation of the average of the major axis lengths, and rᵢ represents the major axis length of i th particle of the measurement.

The value of n is defined as 100 or more, preferably a larger number, and more preferably 200 or more. When n is less than 100, the coefficient cannot reflect the variation of the particles accurately.

In order to determine particle sizes, the average aspect ratios, and the coefficients of variation of carbonates of the present invention, for example, well-dispersed carbonate particles were observed by a transmission electron microscope, the particles are photographed, photographs of the particles are scanned in the scanner and saved as graphics files, each particle in these graphics files is analyzed by Image Analysis Type Particle Size Distribution Analysis software Mac-View ver.3 manufactured by Mountech Co. Ltd and the data of each particle is gathered and used for calculation of values of above properties. If particle images obtained by the transmission electron microscope observation can be beforehand obtained as a jpg image data, data processing using scanner is unnecessary, and in this case the jpg graphics files can be gathered and used for calculation of values of above properties without modification.

### —Applications—

Carbonates produced by the production method for carbonates of the present invention have an average aspect ratio greater than 2, thus, the carbonates are not spherical but are needle-like or rod-like, and therefore, are useful for plastic reinforcing materials, friction materials, heat insulating materials, filters, and the like. Particularly, a composite material that has been subjected to a deformation such as drawn materials allows improvement of the strength and the optical properties by the orientation of the particles.

When carbonates (crystals) produced by the method for producing carbonates of the present invention are dispersed in an optical polymer having birefringence, and the dispersion is subjected to a drawing treatment to thereby orientate the carbonate particles generally parallel to the linked chains of the optical polymer, the birefringence brought by the orientation of the linked chains of the optical polymer can be counteracted with the birefringence of the carbonates.

The drawing treatment is not particularly limited, may be suitably selected depending on the purpose, and examples thereof include uniaxial drawing. Examples of the method of the uniaxial drawing include drawing the dispersion to a desired draw ratio using a drawing machine while heating as required.

Birefringent indexes specific to optical polymers having birefringence are as described on page 29 in Evolving Transparent Resins—World of Sophisticated Optical Materials Challenging IT—First Edition, written by Fumio Ide, published by Kogyo Chosakai Publishing Inc. Table 2 below shows specific examples of the birefringent indexes of the optical polymers having a birefringence. Table 2 shows that many of the optical polymers have a positive birefringence. For example, when strontium carbonate is used as the carbonate and added to polycarbonate as the optical polymer, it is possible to counteract the positive birefringence of the mixture and to make it have zero birefringence as well as to make it have a negative birefringence. For this reason, the carbonates produced according to the present invention can be suitably used for optical components, especially optical elements in which polarizing property is important and high-precision is required.

TABLE 2

| | Birefringent |
|---|---|
| Polymer | Index |
| Polystyrene | −0.10 |
| Polyphenylene ether | 0.21 |
| Polycarbonate | 0.106 |
| Polyvinylchloride | 0.027 |
| Polymethyl methacrylate | −0.0043 |
| Polyethylene | 0.105 |
| terephthalate | |
| Polyethylene | 0.044 |

According to the method for producing carbonates of the present invention, it is possible to easily and efficiently form carbonates having orientation birefringence and an average aspect ratio greater than 2. Further, it is possible to control the size of the carbonate particles as well as to obtain carbonates having a given particle size at high rates.

### EXAMPLES

Hereinafter, the present invention will be described with reference to Examples, however, the present invention is not limited to the disclosed Examples.

In the following Examples and Comparative Examples, particle sizes, average aspect ratios, and coefficients of variation of carbonate crystals are determined by observing well-dispersed carbonate particles using a transmission electron microscope (TEM), photographing the carbonate particles, making graphic files of images thereof, measuring the above values of physical properties for each carbonate particle using Image Analysis Type Particle Size Distribution Analysis software Mac-View ver.3 manufactured by Mountech Co. Ltd., and gathering the graphic file information.

### Example 1

Solution A for Example 1 was prepared by adding 9.96 g of Sr(OH)₂.8H₂O (manufactured by KANTO CHEMICAL CO., LTD.) to 268.5 ml of methanol and by stirring the mixture.

Solution B for Example 1 was prepared by dissolving 9.80 g of ammonium carbonate (manufactured by KANTO CHEMICAL CO., LTD.) and 5.07 g of NaOH granules in a mixture of 750 ml of purified water and 250 ml of methanol.

To solution A for Example 1, which was kept at 5° C. in a temperature-controlled bath and was kept stirred at 700 rpm, 62.5 ml of solution B for Example 1 was added via two nozzles at an adding speed of 0.30 ml/min. After completion of this addition, 61.25 ml of purified water was added, and the temperature was increased to 45° C. and the number of stirring revolutions was further raised to 900 rpm. While keeping the temperature and the number of stirring revolutions, 132.8 ml of solution B for Example 1 was added via two nozzles at an adding speed of 0.90 ml/min.

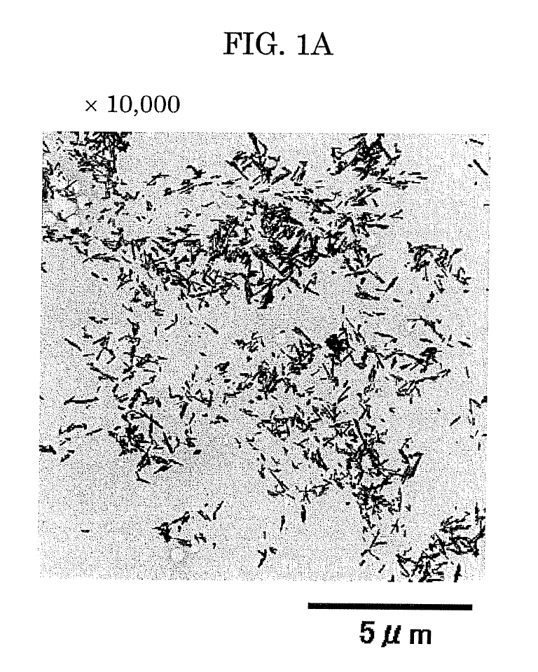

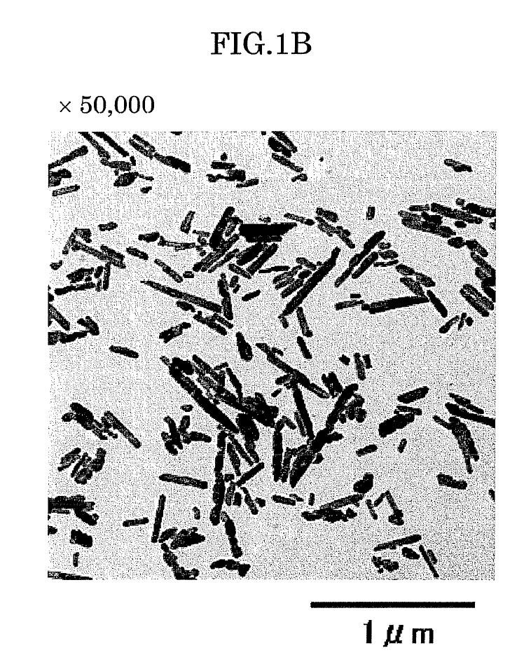

The solution thus obtained was subjected to centrifugation, and the collected precipitate was washed with water, a part of which was observed by a transmission electron microscope (TEM). Results of this observation are shown in FIGS. 1A and 1B. Remaining precipitates were dried at 60° C. and pulverized, and then were subjected to X-ray diffraction (XRD) measurement for identification of crystal phases. From the results of TEM photographs of FIGS. 1A and 1B, particle sizes, average aspect ratios, and coefficients of variation of particles of strontium carbonate were determined. Each result is shown in Table 3.

### Example 2

Solution A for Example 2 was the same as solution A for Example 1.

Solution B for Example 2 was the same as solution B for Example 1 except that methanol (250 ml) was not added.

To solution A for Example 2, which was kept at 8° C. in a temperature-controlled bath and was kept stirred at 700 rpm, 62.5 ml of solution B for Example 2 was added via two nozzles at an adding speed of 0.30 ml/min. After completion of this addition, 61.25 ml of purified water was added, and the temperature was kept at 8° C. and the number of stirring revolutions was further raised to 900 rpm. While keeping the temperature and the number of stirring revolutions, 132.8 ml of solution B was added via two nozzles at an adding speed of 0.90 ml/min.

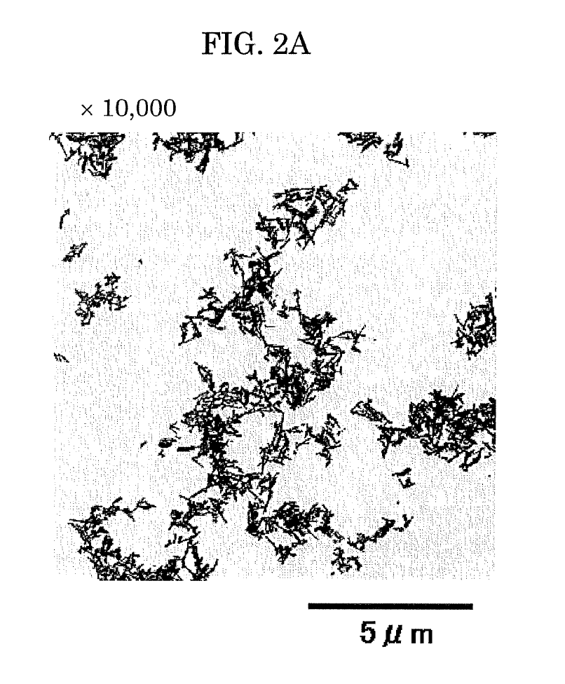

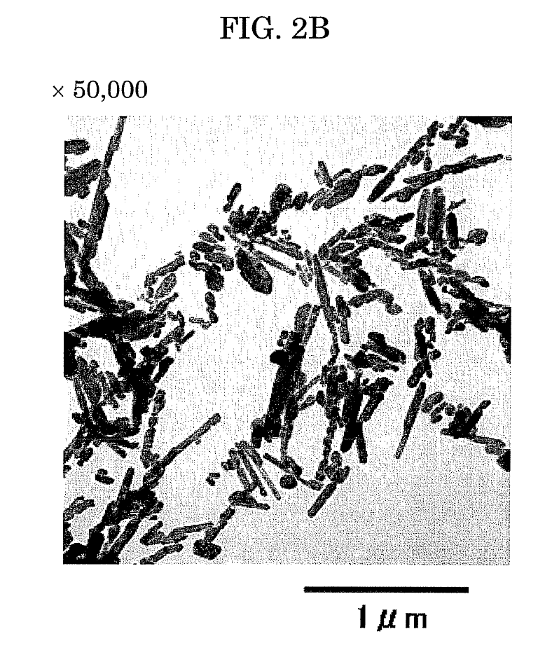

The solution thus obtained was subjected to centrifugation, and the collected precipitate was washed with water, a part of which was observed by a transmission electron microscope (TEM). Results of this observation are shown in FIGS. 2A and 2B. Remaining precipitates were dried at 60° C. and pulverized, and then were subjected to X-ray diffraction (XRD) measurement for identification of crystal phases. From the results of TEM photographs of FIGS. 2A and 2B, particle sizes, average aspect ratios, and coefficients of variation of particles of strontium carbonate were determined. Each result is shown in Table 3.

### Comparative Example 1

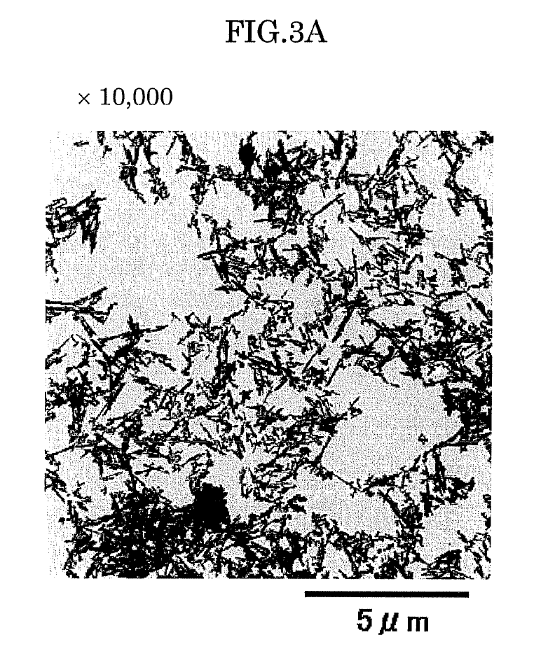

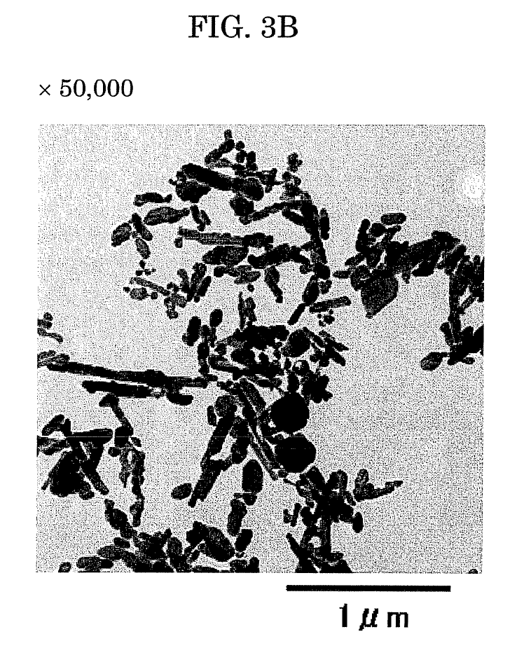

Particles of strontium carbonate were produced following the same procedure as Example 1 except that instead of adding NaOH granules into solution B, 5.07 g of NaOH granules were added into solution A. Results of a transmission electron microscope (TEM) observation of particles of strontium carbonate are shown in FIGS. 3A and 3B. From the results of TEM photographs of FIGS. 3A and 3B, the particle sizes, the average aspect ratios, and the coefficients of variation of the particles of strontium carbonate were determined. Each result is shown in Table 3.

As is shown in Table 3, FIGS. 3A and 3B, although the precipitates thus obtained were identified as particles of strontium carbonate, particles showed a large variation with respect to particle shape, and contained particles having nearly spherical shape and an average aspect ratio 1 or less.

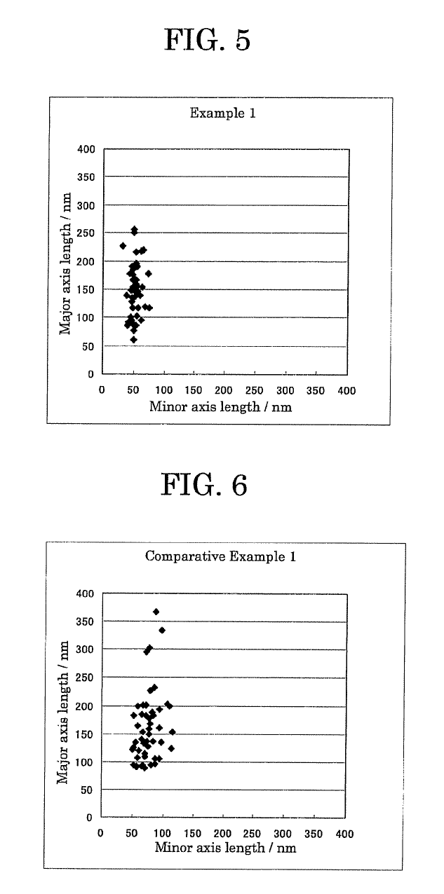

FIG. 5 shows a plot of measured values of major axis length versus minor axis length in Example 1. FIG. 6 shows a plot of measured values of major axis length versus minor axis length in Comparative Example 1. From these results, it was found that Example 1 in FIG. 5 had a smaller variation of major axis length and minor axis length than Comparative Example 1 in FIG. 6.

### Comparative Example 2

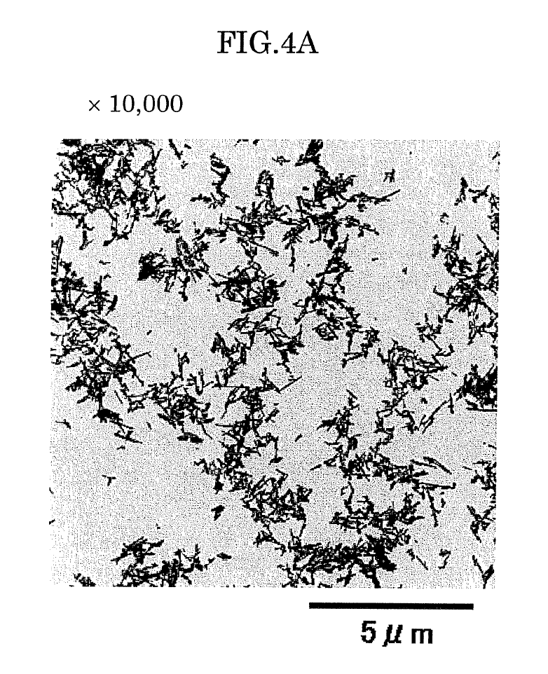

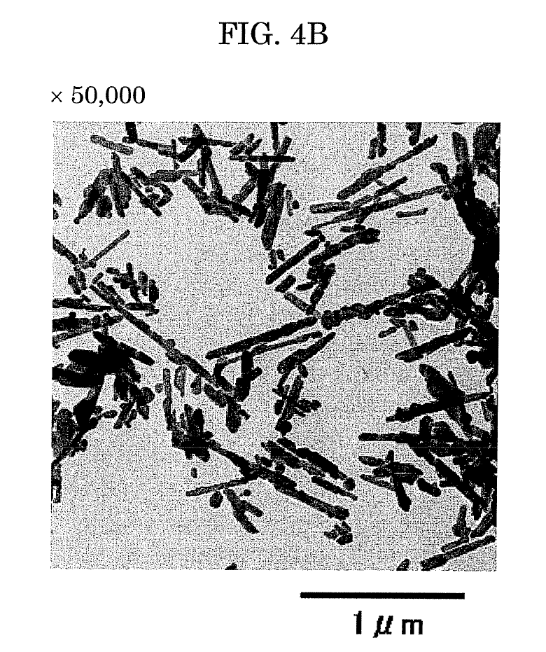

Particles of strontium carbonate were produced following the same procedure as Example 1 except that NaOH granules were not added into solution B. Results of a transmission electron microscope (TEM) observation of particles of strontium carbonate were shown in FIGS. 4A and 4B. From the results of TEM photographs of FIGS. 4A and 4B, the particle sizes, the average aspect ratios, and the coefficients of variation of the particles of strontium carbonate thus obtained were determined. Each result is shown in Table 3.

As is shown in Table 3, FIGS. 4A and 4B, the precipitates thus obtained were identified as particles of strontium carbonate. The precipitates contained particles formed in a variety of particle shapes, however, there was a predominance of particles having an average aspect ratio greater than 1. Further the precipitates contained particles with average major axis length longer than 1 μm.

TABLE 3

| | | | Comparative | Comparative |
|---|---|---|---|---|
| | Example 1 | Example 2 | Example 1 | Example 2 |
| Source of Sr | Sr(OH)₂•8H₂O | Sr(OH)₂•8H₂O | Sr(OH)₂•8H₂O | Sr(OH)₂•8H₂O |
| Solvent of solution containing | Methanol | Methanol | Methanol | Methanol |
| Sr²⁺ ion | | | | |
| Alkali addition to solution | Not added | Not added | Added | Not added |
| containing Sr²⁺ ion | | | NaOH | |
| Source of carbonate | (NH₄)₂CO₃ | (NH₄)₂CO₃ | (NH₄)₂CO₃ | (NH₄)₂CO₃ |
| Solvent for carbonate source | Water + methanol | Water | Water + methanol | Water + methanol |
| Alkali addition to carbonate | Added | Added | Not added | Not added |
| source | NaOH | NaOH | | |
| Reaction temperature | 5° C.→45° C. | 8° C. | 5° C.→45° C. | 5° C.→45° C. |
| pH after completion of reaction | 12.6 | 12.9 | 13.1 | 9.7 |
| Composition of particles obtained | SrCO₃ | SrCO₃ | SrCO₃ | SrCO₃ |
| TEM photographs | FIGS. 1A and | FIGS. 2A and | FIGS. 3A and | FIGS. 4A and |
| | 1B | 2B | 3B | 4B |
| Average major axis length (nm) | 147.8 | 183.8 | 205.8 | — |
| Coefficient of variation of average | 31.4 | 42.0 | 50.5 | — |
| major axis length (%) | | | | |
| Average minor axis length (nm) | 52.8 | 63.1 | 68.3 | — |
| Coefficient of variation of average | 15.4 | 19.2 | 22.1 | — |
| minor axis length (%) | | | | |
| Average aspect ratio | 2.8 | 3.1 | 3.0 | — |

* Numerical data calculated from TEM photographs for Comparative Example 2 are omitted because it is obvious from FIGS. 4A and 4B that there were particles having an average major axis length longer than 1 μm.

The method for producing carbonates of the present invention can control particle sizes and efficiently and easily produce carbonates having a given particle size with a high yield.

Since the carbonates produced by the production method of the present invention have a high crystallinity, are hardly flocculate, and have an aspect ratio greater than 1 (especially they are needle-like or rod-like shapes), they orient less in a molded component, show isotropy, and can be suitably used for plastic reinforcing materials, friction materials, heat insulating materials, filters, and the like. Particularly in composite materials deformed by drawing, etc., it is possible to improve their strength and optical properties because the carbonate particles orient.

When carbonates (crystals) produced by the production method of the present invention are dispersed in an optical polymer having birefringence and the dispersion is subjected to a drawing treatment to thereby orientate the carbonate particles generally parallel to linked chains of the optical polymer, the birefringence brought by the orientation of the linked chains of the optical polymer can be counteracted with the birefringence of the carbonates. Thus the carbonates produced according to the present invention can be suitably used for optical components, especially optical elements in which polarizing property is important and high-precision is required.

What is claimed is:

1. A method for producing carbonates, comprising:
adding an aqueous solution containing a carbonate source into an alcoholic solution containing a metal ion source,
wherein an alkaline chemical is added when the carbonate source is reacted with the metal ion source.

2. The method for producing carbonates according to claim 1, wherein a metal ion in the metal ion source is Sr²⁺.

3. The method for producing carbonates according to claim 1, wherein the alkaline chemical is added to the aqueous solution containing a carbonate source.

4. The method for producing carbonates according to claim 1, wherein the alkaline chemical comprises at least one selected from the group consisting of NaOH, KOH, and LiOH.

5. The method for producing carbonates according to claim 1, wherein an alcohol is added to the aqueous solution containing a carbonate source.

6. The method for producing carbonates according to claim 1, wherein the aqueous solution containing a carbonate source is added at least at two different temperatures in the order of higher temperature.

7. The method for producing carbonates according to claim 1, wherein the aqueous solution containing a carbonate source is added at a first temperature of 10° C. or lower and at a second temperature of 30° C. or higher.

8. The method for producing carbonates according to claim 1, wherein the metal ion source comprises at least one selected from the group consisting of hydroxides, chlorides, and nitrates of strontium, and the carbonate source comprises at least one selected from the group consisting of sodium carbonates, potassium carbonates, and ammonium carbonates.

9. Carbonates produced by a method for producing carbonates,
wherein the production method comprises at least adding an aqueous solution containing a carbonate source into an alcoholic solution containing a metal ion source,
wherein an alkaline chemical is added when the carbonate source is reacted with the metal ion source.

10. The carbonates according to claim 9, wherein the carbonates have an average aspect ratio of two or more and an average major axis length of shorter than 1 μm.

11. Carbonates, having an average major axis length of less than 200 nm, a coefficient of variation of the average major axis length of 45% or less, and an average minor axis length of less than 65 nm and a coefficient of variation of the average minor axis length of 20% or less.
